(19) United States
(12) Patent Application Publication
(10) Pub. No.: US 2008/0242144 A1
(43) Pub. Date: Oct. 2, 2008

(54) Device for holding at least two connecting cables

(75) Inventor: Carsten Dietz, Blumberg (DE)

Correspondence Address: NATH & ASSOCIATES, 112 South West Street, Alexandria, VA, 22314, US

(73) Assignee: MC Technology GmbH, Blumberg (DE)

(21) Appl. No.: 12/076,699

(22) Filed: Mar. 21, 2008

(30) Foreign Application Priority Data
Mar. 28, 2007 (DE) 10 2007 014 755.6

(51) Int. Cl. H01R 13/60

(52) U.S. Cl. 439/540.1

(57) ABSTRACT

The invention relates to a device (10, 10′, 10″) for holding at least two connecting cables (40), with a support element (20, 20′, 20″) in which are positioned at least two recesses (22, 22′, 22″) which, proceeding from the rim of the support element (20, 20′, 20″), exhibit an insertion area (24, 24′, 24″) adjoined by a holding area (26, 26′, 26″), in which a connecting cable (40) is in each case positioned.

The invention also relates to a process for replacing apparatus (50) to which at least two connecting cables (40) are attached by means of a detachable connection, preferably a plug connection, such that each connecting cable (40) is first introduced into the holding area (26, 26′, 26″) of a recess (22, 22′, 22″) belonging to a device (10, 10′, 10″) according to one of the preceding claims and the detachable connection of the connecting cables (40) to the apparatus (50) is then terminated, the apparatus (50) is replaced, the detachable connection of the connecting cables (40) to the replaced apparatus (50) is restored, and finally the connecting cables (40) are removed from the recesses (22, 22′, 22″) of the device (10, 10′, 10″).

For equipment that employs a number of connecting cables, particularly in the form of switches or patch fields as used in network technology, the replacement of defective or old equipment represents a considerable labor input involving a high risk of error, inasmuch as all connecting cables must be removed from the apparatus and the connecting cables may be mistakenly transposed upon reinsertion. As is generally known, when such an apparatus is replaced each connecting cables must be labeled with its correct position and only then withdrawn from the apparatus. Upon reconnection, the cables must be inserted into the correct connecting sockets of the apparatus, as indicated by the labels, and care must be taken to prevent the cables from being needlessly confused.

The goal of the invention therefore consists in providing a device which noticeably simplifies the replacement of an apparatus which employs a plurality of connecting cables. The further goal of the invention is propose a process for the replacement of an apparatus that has a plurality of connecting cables.

The goal of the invention is achieved with a device for holding in position at least two connecting cables, in accordance with the features of patent claim 1, and with a process for replacing apparatus, in accordance with the features of patent claim 10.

Advantageous embodiments and elaborations are indicated in the secondary claims.

The invention proposes a device for supporting at least two connecting cables, with a support element in which at least two recesses are positioned. Starting from the rim of the support element, these recesses exhibit an insertion area, adjacent to which is a holding area in which the given connecting cable is positioned. The connecting cables of an apparatus can be inserted into their correct positions in the recesses of the support element, where they are held before their connection with the apparatus is interrupted. The device thus holds the individual connecting cables in the position which they occupy relative to each other when inserted in the apparatus and to which they must return after the apparatus is replaced. When the apparatus is replaced the connecting cables are simply reinserted into their pre-assigned position in the apparatus. The time-consuming process of labeling the individual connecting cables is completely eliminated. In addition, it is insured that each connecting cable is attached to the corresponding and correct connecting socket in the apparatus. Confusion among the connecting cables during the process of replacing the apparatus is eliminated, since the cable ends are held in their correct positions relative to another.

The insertion area advantageously widens toward the rim of the support element to enable the simple introduction of the connecting cable into the insertion area up to the holding area.

The insertion area is preferably bordered by rigid lateral surfaces, such that the force that holds the connecting cable is provided by a deformation of the connecting cable. As an alternative, the insertion area may also be bordered by flexible lateral surfaces, such that the force holding the connecting cables in place is provided by the deformation of the lateral surfaces, which specifically may take the form of elastic elements.

It is particularly preferred if the holding area forms an undercut on both sides of the insertion area, in the place where holding area borders the insertion area. This undercut helps position the connecting cable in the holding area.

The holding area advantageously exhibits a cross-section that is basically circular in shape. This permits the holding area to rest against the connecting cable with a form-fit and thereby guarantees a secure seat for the connecting cable.

In an advantageous embodiment of the invention the support element exhibits six, eight, twelve, sixteen, or twenty-four recesses, in order to receive the corresponding number of connecting cables.

It is particularly preferred if the support element has an elongated shape, such that the recesses are positioned on at least one, but preferably both, longitudinal sides, in order to match the configuration of plug sockets on the apparatus into which the connecting cables are inserted.

It is particularly preferred if the support element is made of metal or plastic, to thereby permit as favorable a possible a manufacturing process as and to insure that the support element is sufficiently stable.

In the process according to the invention for replacing apparatus involving at least two connecting cables and a detachable connection, ideally a plug connection, one of the connecting cables is first inserted into the holding area of a recess belonging to the device according to the invention. Then the detachable connection of the connecting cables to the apparatus is undone, thereby permitting the apparatus to be replaced. After the apparatus is replaced, the detachable connection of the connecting cables to the replaced apparatus is restored and the connecting cables are removed from the recesses in the device. It is completely unnecessary to label the connecting cables in order to identify the correct connecting socket in the apparatus after the connecting cables have been detached. Moreover, there is no confusion among the cables, since insertion of connecting cables into the device for holding the connecting cables results in said connecting cables being fixed in their correct positions relative to each other. Replacing an apparatus that has a plurality of connecting cables is noticeably simplified.

The invention is next described in detail on the basis of the following figures.

Shown are:

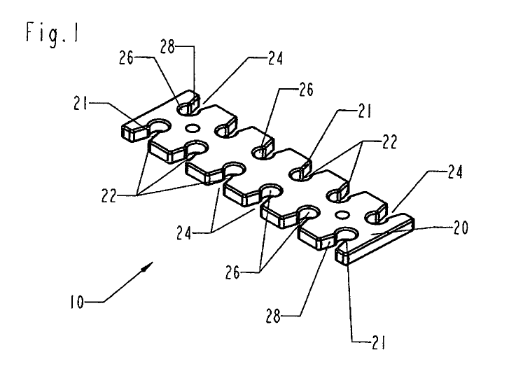

FIG. 1 a perspective view of an initial exemplary embodiment of the invention

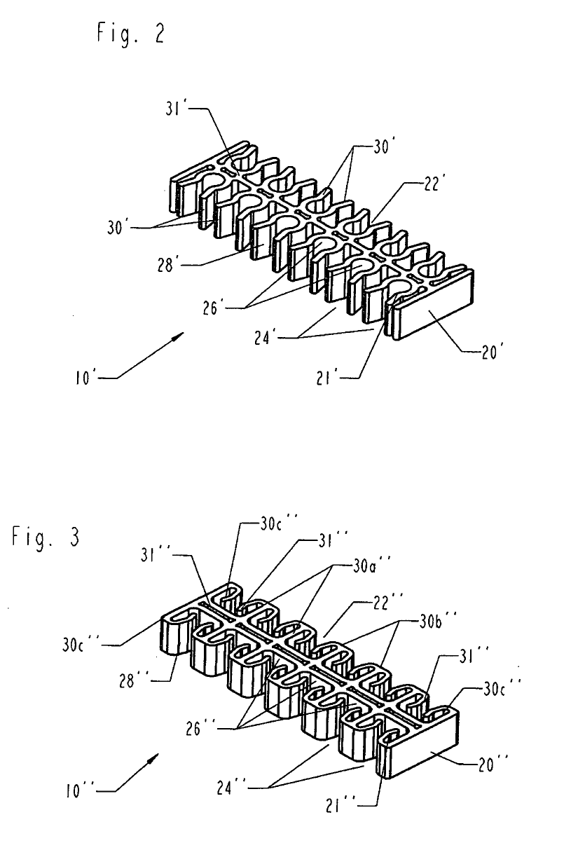

FIG. 2 a perspective view of a second exemplary embodiment of the invention

FIG. 3 a perspective view of a third exemplary embodiment of the invention

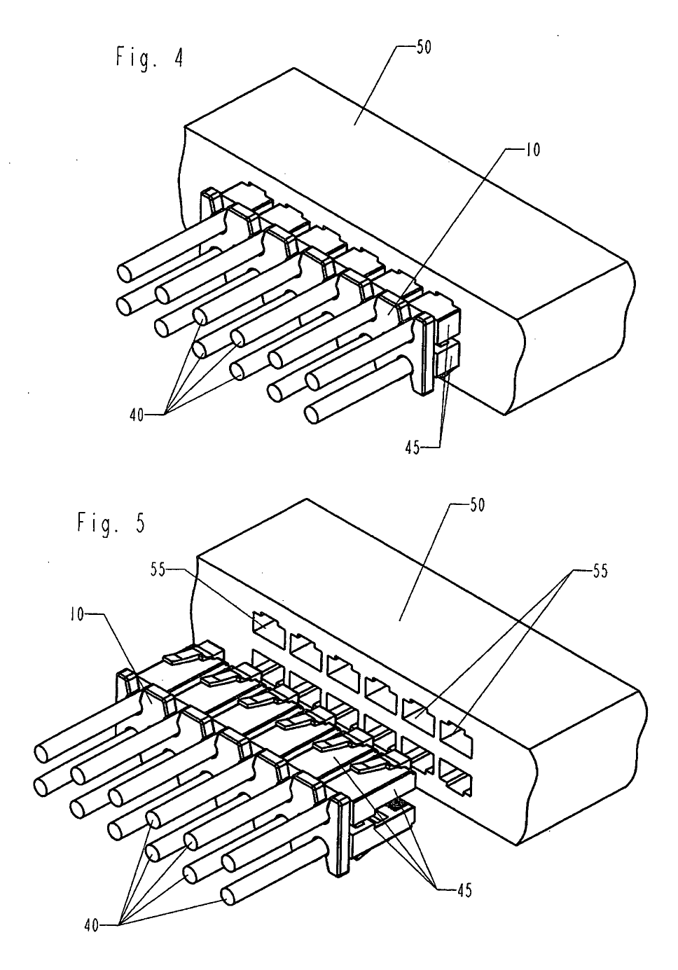

FIG. 4 a schematic depiction of the exemplary embodiment of FIG. 1, as applied in an initial step

FIG. 5 a schematic depiction of the exemplary embodiment of FIG. 2, as applied in a second step.

FIG. 1 shows a perspective view of an initial exemplary embodiment of a device 10 for holding connecting cables. The device 10 exhibits a support element 20, which is basically rectangular or elongated in shape. Starting from the rim of the support element 20, six recesses 22, each of which has an insertion area 24 and a holding area 26, are applied to both longitudinal sides of said support element 20. The insertion area 24 borders the rim of the support element 20, while the holding area 26 adjoins the insertion area 24. Moving from the rim of the support element 20 toward the holding area 26, the insertion area 24 narrows in size, so that connecting cables can be easily inserted through this insertion area 24 and into the holding area 26. The transition between the insertion area 24 and the holding area 26 forms an undercut 21, specifically in that the holding area 26 grows wider in the area immediately adjoining the insertion area 24. To achieve this effect the holding area 26 has a basically circular cross-section. The recesses 22 here are each bordered by a rigid lateral area or surface 28. The lateral areas 28 are rigid inasmuch as the recesses 22 are located in the otherwise open surface of the support element 20. The support element 20 can be made of plastic or metal. The connecting cables are guided through the insertion area 24 and into the holding area 26 of the recesses 22 in such a way that the connecting cables, in entering the holding area 26, intersect the support element 20 with their longitudinal axis and in basically perpendicular fashion.

FIG. 2 shows a perspective view of a second exemplary embodiment of a device 10′ for holding connecting cables, with a support element 20′ which exhibits a plurality of recesses 22′, specifically twelve recesses 22′, each of which has an insertion area 24′ and a holding area 26′. The support element 20′ has a longitudinal bridge 31′, on either side of which elastic elements 30′ are positioned in a manner basically perpendicular to the longitudinal axis of the longitudinal bridge 31′. In each case a recess 22′ is formed by two adjacent elastic elements 30′. In particular, the facing surfaces of any two elastic elements 30′ forming a recess 22′ create a lateral area 28′ which borders the recess 22′. Proceeding from the longitudinal bridge 31′, the two elastic elements 30′ forming the recess 22′ first bend away from each other in the form of an arc and then bend toward each other to thereby form the holding area 26′ of the recess 22′, which thus exhibits a cross-section that is circular in shape. In the area neighboring the holding area 26′ the elastic elements 30′ are shaped in such a way that they open at an acute angle and there form the insertion area 24′, which widens toward the outside of the support element 20′, proceeding from the holding area 26′. The six recesses 22′ are positioned in this manner on either side of the longitudinal bridge. The elastic elements 30′ all basically have the same length, with the result that the support element 20′ has an elongated shape. The support element 20′ can be made of metal or plastic, though plastic is preferred for this embodiment, in order to allow the support element 20′ to be economically produced by means of injection molding. If a connecting cable is inserted through the insertion area 24′ and into the holding area 26′, the elastic elements 30′ will yield slightly to permit the connecting cable to pass through the narrowest point of the insertion area 24′ and into the holding area 26′. Due to their elastic resistance, the elastic elements 30′ hold the connecting cable firmly within the holding area 26′, which is penetrated in basically perpendicular fashion by the connecting cable.

FIG. 3 gives a perspective view of a third exemplary embodiment of a device 10″ for holding connecting cables, with a support element 20″ in which a plurality of recesses 22″, specifically twelve recesses, are positioned. The recesses 22″ each exhibit an insertion area 24″ and a holding area 26″ and are bordered by a lateral area 28″. The support element 20″ has a longitudinal bridge 31″ on either side of which a number of elastic elements 30″ are positioned in basically perpendicular fashion. The elastic elements 30″ that do not lie at the end of the longitudinal bridge 31″ of the support element 20″ have a U-shaped section 30b″, which widens in the direction of the longitudinal bridge 31″ and is positioned over a bridge 30a″ on the longitudinal bridge 31″. The bridge 30a″ connects the U-shaped section 30b″ with the longitudinal bridge 31″, proceeding from the base of the U-shaped section 30b″. So that the support element 30″ has a smooth longitudinal side on its terminal faces, two elastic elements 30c″, whose shape is roughly half that of the elastic element 30″, are positioned on the ends of the longitudinal bridge 31″. The insertion area 24′″ of a recess 22″ is formed between the two facing legs of any two adjacent U-shaped sections 30b″ belonging to two neighboring elastic elements 30″. The unattached ends of the legs of the U-shaped sections 30b″ form an undercut 21″ at the transitional area between the insertion area 24″ and the holding area 26″. The legs of the U-shaped sections 30b″ and the bridges 30a″ of the elastic elements 30″ are flexible and spring-like in design, in order to facilitate the insertion of the connecting cables into the holding area 26″ and to permit the connecting cables to be securely held within the holding area 26″.

FIGS. 4 and 5 show how the device 10″ of FIG. 1 is put to use. Positioned on the apparatus 50 are a plurality of connecting sockets, in which a number of connecting cables 40 are inserted by means of plugs 45. The apparatus 50 here has twelve connecting sockets arranged in two parallel rows, so that six connecting sockets are positioned in each row. The support element 20 of the device 10 has six recesses 22 along each of its two longitudinal sides. Inserted into each of these recesses 22 is a connecting cable 40, which then runs through the holding area 26 of the recess 22 in basically perpendicular fashion. In the process, connecting cables 40 lying next to each other in a row are positioned in recesses 22 lying adjacent to each other in the support element 20. The connecting cables 40 in one row come to rest in the recesses 22 along one of the two longitudinal sides of the support element 20, while the connecting cables 40 of the other row of connecting sockets 55 are fixed into position in the recesses 22 lying on the opposite longitudinal side of the support element 20. All together the support element 20 thus positions all connecting cables 40 in their exact positions relative to each other. As FIG. 5 shows, all the connecting cables 40 can then be pulled out of the apparatus 50 by removing the plugs 45 from the connecting sockets 55. In the process, the support element 20 continues to hold the connecting cables 40 in their relative positions. The apparatus 50 can be replaced or removed for a short term without the need for labeling the individual connecting cables 40 to indicate the specific sockets to which they must be returned. In particular, the connecting cables 40 remain fixed in their relative positions, without any confusion arising among them. After replacement, repair, or other maintenance of the apparatus 50, all connecting cables 40 can then be reinserted into their appropriate connecting sockets 55, and the support element 20 insures that no connecting cable is mistaken and inserted into the wrong socket 55. Replacement of the apparatus 50 is thus simplified in to a noticeable degree.

### LIST OF REFERENCE NUMERALS

10, 10′, 10″ device
20, 20′, 20″ support element
21, 21′, 21″ undercut
22, 22′, 22″ recess
24, 24′, 24″ insertion area
26, 26′, 26″ holding area
28, 28′, 28″ lateral surface
30′, 30″ elastic element
30a″ bridge
30b″ U-shaped section
30c″ elastic element
31′, 31″ longitudinal bridge
40 connecting cable
45 plug
50 apparatus
   55 connecting socket

1. Device (10, 10′, 10″) for holding at least two connecting cables (40), with a support element (20, 20′, 20″) in which are positioned at least two recesses (22, 22′, 22″) which, proceeding from the rim of the support element (20, 20′, 20″), exhibit an insertion area (24, 24′, 24″) adjoined by a holding area (26, 26′, 26″), in which a connecting cable (40) is in each case positioned.

2. Device according to claim 1,
wherein
the insertion area (24, 24′, 24″) widens toward the rim of the support element (20, 20′, 20″)

3. Device according to claim 1,
wherein
the insertion area (24) is bordered by rigid lateral surfaces (28).

4. Device according to claim 1,
wherein
the insertion area (24, 24′, 24″) is bordered by flexible lateral surfaces (28′, 28″), particularly by elastic or spring-like lateral surfaces.

5. Device according to claim 1,
wherein
the holding area (26, 26′, 26″) forms an undercut (21, 21′, 21″) on both side of the insertion area (24, 24′, 24″) in the area adjoining the insertion area (24, 24′, 24″).

6. Device according to claim 1,
wherein
the holding area (26, 26′, 26″) has a basically circular cross-section.

7. Device according to claim 1,
wherein
the support element (20, 20′, 20″) has six, eight, twelve, sixteen, or twenty-four recesses (22, 22′, 22″).

8. Device according to claim 1,
wherein
the support element (20, 20′, 20″) has an elongated shape, such that the recesses (22, 22′, 22″) are positioned on at least one and preferably both longitudinal sides.

9. Device according to claim 1,
wherein
the support element (20, 20′, 20″) is made of metal or plastic.

10. Process for replacing apparatus (50) to which at least two connecting cables (40) are attached by means of a detachable connection, preferably a plug connection, such that each connecting cable (40) is first introduced into the holding area (26, 26′, 26″) of a recess (22, 22′, 22″) belonging to a device (10, 10′, 10″) according to claim 1 and the detachable connection of the connecting cables (40) to the apparatus (50) is then terminated, the apparatus (50) is replaced, the detachable connection of the connecting cables (40) to the replaced apparatus (50) is restored, and finally the connecting cables (40) are removed from the recesses (22, 22′, 22″) of the device (10, 10′, 10″).
